(19) United States
(12) Patent Application Publication
(10) Pub. No.: US 2026/0049188 A1
(43) Pub. Date: Feb. 19, 2026

(54) HYDROGEL SPACERS FOR ABLATION THERAPIES

(71) Applicant: Boston Scientific Scimed, Inc., Maple Grove, MN (US)

(72) Inventors: Cristian Parisi, Amherst, MA (US); Rick William Dorn, Plymouth, MN (US); Nicolas Ball-Jones, Minneapolis, MN (US); Joseph Thomas Delaney, JR., Minneapolis, MN (US)

(73) Assignee: Boston Scientific Scimed, Inc., Maple Grove, MN (US)

(21) Appl. No.: 19/298,973

(22) Filed: Aug. 13, 2025

Related U.S. Application Data
(60) Provisional application No. 63/683,575, filed on Aug. 15, 2024.

(51) Int. Cl. C08J 3/075; C08J 9/228

(52) U.S. Cl. CPC C08J 3/075; C08J 9/228; C08J 2300/16

(57) ABSTRACT

In some embodiments, the present disclosure pertains to an insulative hydrophilic polymer hydrogel compositions for ablation therapies. An example insulative hydrophilic polymer hydrogel composition comprises: a hydrophilic polymer hydrogel, the hydrophilic polymer hydrogel comprising hydrophilic polymer chains that are crosslinked by crosslinks; and a plurality of gas bubbles disposed in the hydrophilic polymer hydrogel.

### CROSS-REFERENCE TO RELATED APPLICATIONS

This application claims the benefit of U.S. Provisional Patent Application Ser. No. 63/683,575 filed on Aug. 15, 2024, the disclosure of which is incorporated herein by reference.

### FIELD

The present disclosure relates to systems and methods for hydrogel spacers. Such systems and methods for hydrogel spacers are useful, for example, in ablation therapies that employ radiation (e.g., radiofrequency energy) and/or thermal energy (heat or cold) to ablate tissue in patients.

### BACKGROUND

Hydrogels with shear-thinning properties are known to undergo a reversible gel-sol transition upon the application of shear stress. J. Pushpamalar, et al., “Development of a polysaccharide-based hydrogel drug delivery system (DDS): An update.” Gels, 2021, 7 (4), p.153. Shear-thinning hydrogels are increasingly used in drug delivery systems as a result of their ability to conform to the shape of an injection cavity, which maximizes contact with targeted tissue for localized drug delivery. Id. Hydrogels with shear-thinning properties have been reported to provide smooth injection without injection needle clogging (e.g., partial or complete flow restriction), with the hydrogels returning to their original properties once mechanical load (shear stress) is removed. M. H. Chen, et al., “Methods to assess shear-thinning hydrogels for application as injectable biomaterials.” ACS Biomater. Sci. Eng. 2017, 3, 3146-3160. Hydrogels assembled by physical crosslinking of polyvinyl alcohol (PVA) and polyvinyl pyrrolidone (PVP) and containing doxorubicin have been noted to be able to deform under high shear and subsequently retain their original shape upon the removal of the high shear, demonstrating both shear-thinning and self-healing properties. N. K. Prasad, et al., “Discerning the self-healing, shear-thinning characteristics and therapeutic efficacy of hydrogel drug carriers migrating through constricted microchannel resembling blood microcapillary,” Colloids Surf. A Physiochem. Eng. Asp. 2021, 626, 127070. FIG. 1 on page 5 of J. Pushpamalar, et al., schematically illustrates the shear-thinning and self-healing properties of a doxorubicin-loaded poly(vinyl alcohol)/poly(vinyl pyrrolidone) hydrogel. A shear-thinning hydrogel containing gelatin and laponite for localized drug delivery and further containing chitosan and poly(N-isopropylacrylamide-co-acrylic acid) particles to render the hydrogel pH-responsive has also been reported. S. Gharaie, et al., “Smart shear-thinning hydrogels as injectable drug delivery systems.” Polymers, 2018, 10 (12), p.1317.

Injectable hydrogels have been used to create or maintain space between tissues in order to reduce side effects of off-target radiation therapy. As an example, the hydrogel can create a space between the rectum and the prostate, moving the rectum away from the treatment region. This can help to reduce radiation exposure to the rectum and/or provide other desirable benefits.

SpaceOAR® and SpaceOAR Vue® are hydrogels that rapidly form crosslinks in vivo. They are based on multi-arm polyethylene (PEG) polymers having a polyol residue core functionalized with succinimidyl glutarate (SG) activated ester end groups. Above a specific pH, the SG groups will rapidly react with a trilysine crosslinker in vivo to form a hydrogel. The hydrogels break down in-vivo over the course of ca. 6-9 months before the hydrogels are completely expelled. The breakdown occurs primarily through the hydrolysis of the ester linkages on the glutarate groups. For instance, upon exposure to water (H₂O) an ester linkage can be hydrolyzed breaking down the hydrogel into a hydroxyl-terminated PEG and a (3-carboxylpropyl)amide-terminated-lysine residue.

Ablation therapies may be employed to treat tissue (e.g., diseased tissue) associated with a variety of conditions or diseases. Examples of ablation therapies included electrode-based radiofrequency ablation (RFA) techniques the employ radiation in the form of radiofrequency (RF) energy to ablate tissue and thermal ablation techniques (e.g., that employ heat and/or cold such a cryogenic ablation treatments) to ablate tissue.

The development of hydrogels that demonstrate insulative properties (e.g., in combination with triggered/on-demand degradation) opens up the door for many medical applications, including hydrogel-based ablation spacing, among many others, where the hydrogel can provide insulation (e.g., thermal insulation and/or insulation for off-target radiation) and, in some instances, may persist only until the procedure/therapy is complete or it is otherwise desirable to remove the hydrogel.

### SUMMARY

In an aspect, an insulative hydrophilic polymer hydrogel composition for ablation therapies is provided. The insulative hydrophilic polymer hydrogel composition comprising: a hydrophilic polymer hydrogel, the hydrophilic polymer hydrogel comprising hydrophilic polymer chains that are crosslinked by crosslinks; and a plurality of gas bubbles disposed in the hydrophilic polymer hydrogel.

In some aspects, which can be used in conjunction with any of the above aspects, wherein the plurality of gas bubbles includes argon bubbles, helium bubbles, krypton bubbles, xenon bubbles, carbon dioxide bubbles, air bubbles, nitrogen bubbles, perfluorooctylbromide bubbles, perfluorodecalin bubbles, perfluorobutane bubbles, perfluoropropane bubbles, perfluorohexane bubbles, or any combination thereof.

In some aspects, which can be used in conjunction with any of the above aspects, wherein the plurality of gas bubbles comprises argon bubbles, helium bubbles, krypton bubbles, xenon bubbles, carbon dioxide bubbles, nitrogen bubbles, or combination thereof.

In some aspects, which can be used in conjunction with any of the above aspects, wherein the plurality of gas bubbles includes carbon dioxide gas bubbles.

In some aspects, which can be used in conjunction with any of the above aspects, wherein the plurality of gas bubbles comprises about 1 volume percent to about 40 volume percent of a total volume of the insulative hydrophilic polymer hydrogel composition.

In some aspects, which can be used in conjunction with any of the above aspects, wherein the plurality of gas bubbles comprises about 10 volume percent to about 40 volume percent of a total volume of the insulative hydrophilic polymer hydrogel composition.

In some aspects, which can be used in conjunction with any of the above aspects, wherein each of the plurality of gas bubbles has an average diameter in a range from about 1 micron to about 10,000 microns.

In some aspects, which can be used in conjunction with any of the above aspects, wherein the plurality of gas bubbles is substantially uniformly disposed throughout the hydrophilic polymer hydrogel.

In some aspects, which can be used in conjunction with any of the above aspect, wherein the plurality of gas bubbles is embedded within cells of a foam, and wherein the foam is an open cell foam or a closed cell foam.

In some aspects, which can be used in conjunction with any of the above aspects, wherein the plurality of gas bubbles is embedded in a shell.

In some aspects, which can be used in conjunction with any of the above aspects, wherein the shell is a polymer shell, and wherein the polymer shell is a polymer bead.

In some aspects, which can be used in conjunction with any of the above aspects, wherein the shell is a polymer shell, and wherein the polymer shell is a polymer balloon.

In some aspects, which can be used in conjunction with any of the above aspects, wherein the insulative hydrophilic polymer hydrogel composition is biodegradable, chemically inert, or both biodegradable and chemically inert.

In some aspects, which can be used in conjunction with any of the above aspects, wherein at least some gas bubbles of the plurality of gas bubbles are disposed in interstitial spaces between the crosslinks of the hydrophilic polymer hydrogel.

In some aspects, which can be used in conjunction with any of the above aspects, wherein the crosslinks comprise: an immolative linker or a reversible covalent linkage that incorporates a reactive dimeric linker; or a hydrolysable linkage selected from a carbonate linkage, an acid anhydride linkage, an imide linkage, a ketal linkage, a carbamate linkage, an organophosphate ester linkage, a silane linkage, an amide linkage, a hydrozonium linkage, an acylhydrozone linkage, an oxime linkage and an amidohydrozone linkage.

In another aspect, a kit for forming an insulative polymer hydrogel composition for ablation therapies is provided. The kit comprising: a hydrogel delivery system configured to deliver an insulative hydrophilic polymer hydrogel to a subject, the insulative hydrophilic polymer hydrogel including: hydrophilic polymer chains that are crosslinked by crosslinks; a plurality of gas bubbles, wherein at least some gas bubbles of the plurality of gas bubbles are disposed in interstitial spaces between the crosslinks; and a hydrogel cleavage system configured to deliver a cleavage composition to the subject.

In some aspects, which can be used in conjunction with any of the above aspects, wherein the insulative polymer hydrogel composition is a preformed insulative polymer hydrogel composition.

In another aspect, a method of forming an insulative hydrophilic polymer hydrogel composition for ablation therapies is provided. The method comprising: forming a plurality of gas bubbles in a hydrophilic polymer hydrogel to form an insulative hydrophilic polymer hydrogel composition for ablation therapies; and delivering the insulative hydrophilic polymer hydrogel composition to a subject.

In some aspects, which can be used in conjunction with any of the above aspects, further comprising delivering a hydrogel cleavage composition to the subject such that the hydrogel cleavage composition contacts the insulative hydrophilic polymer hydrogel composition to break at least some crosslinks in the insulative hydrophilic polymer hydrogel composition.

In some aspects, which can be used in conjunction with any of the above aspects, further comprising forming the gas bubbles before delivering the insulative hydrophilic polymer hydrogel to the subject, while delivering the insulative hydrophilic polymer hydrogel, or after delivering the hydrophilic polymer hydrogel to the subject.

The above and other aspects, embodiments, features and benefits of the present disclosure will be readily apparent from the following detailed description.

### BRIEF DESCRIPTION OF THE DRAWINGS

FIG. 1 is a schematic depiction of a region of the human body.

FIG. 2 depicts the placement of an insulative hydrophilic polymer hydrogel spacer in the region of the human body depicted in FIG. 1.

FIG. 3 depicts the delivery of a cleavage composition to the insulative hydrophilic polymer hydrogel spacer of FIG. 2.

FIG. 4 depicts the region of the human body of FIG. 3 after degradation of the insulative hydrophilic polymer hydrogel spacer.

FIG. 5 schematically illustrates a pre-loaded syringe that contains an injectable cleavage composition, in accordance with an embodiment of the present disclosure.

FIG. 6 schematically illustrates a delivery device for delivering an insulative hydrophilic polymer hydrogel, in accordance with an embodiment of the present disclosure.

FIG. 7 schematically illustrates a delivery device for forming an insulative hydrophilic polymer hydrogel in situ, in accordance with an embodiment of the present disclosure.

### DETAILED DESCRIPTION

The present disclosure pertains hydrogels that demonstrate insulative properties (e.g., thermal insulation and/or insulation for off-target radiation) and, in some instances, may persist only until a procedure/therapy is complete or it is otherwise desirable to remove the hydrogel (degrading a hydrophilic polymer hydrogel in situ (i.e., within a subject).

In some embodiments, an insulative hydrophilic polymer hydrogel composition for ablation therapies is provided. The insulative hydrophilic polymer hydrogel composition includes a crosslinked hydrophilic polymer hydrogel and a plurality of gas bubbles disposed in the crosslinked hydrophilic polymer hydrogel. Examples of suitable hydrophilic polymer hydrogels are described herein.

The insulative hydrophilic polymer hydrogel compositions herein can exhibit enhanced insulative properties (e.g., enhanced thermal insulation properties) at least due to the presence of gas bubbles disposed therein. For instance, a relatively high amount of the gas bubbles present in the insulative hydrophilic polymer hydrogel compositions herein are greater than any amount of entrained or otherwise trapped gas (e.g., air) that may inherently or inadvertently be disposed within a typical hydrogel e.g., during formation thereof. For instance, the gas bubbles can comprise about 1 volume percent to about 40 volume percent of a total volume of the insulative hydrophilic polymer hydrogel compositions herein. All individual values and ranges from about 1 volume percent to about 40 volume percent are included. For instance, in some embodiments, the gas bubbles can comprise greater than about 5 volume percent, greater than about 10 volume percent, greater than about 15 volume percent, greater than about 20 volume percent, greater than about 25 volume percent or greater than about 30 volume percent based on a total volume of an insulative crosslinked hydrogel composition. In some embodiments, the gas bubbles can comprise about 10 volume percent to about 40 volume percent of a total volume of an insulative hydrophilic polymer hydrogel composition. In some embodiments, the gas bubbles can comprise about 10 volume percent to about 30 volume percent of a total volume of an insulative hydrophilic polymer hydrogel composition. In some embodiments, the gas bubbles can comprise about 10 volume percent to about 25 volume percent of a total volume of an insulative hydrophilic polymer hydrogel composition. In some embodiments, the gas bubbles can comprise about 15 volume percent to about 30 volume percent of a total volume of an insulative hydrophilic polymer hydrogel composition. In some embodiments, the gas bubbles can comprise about 5 volume percent to about 30 volume percent of a total volume of an insulative hydrophilic polymer hydrogel composition. In some embodiments, the gas bubbles can comprise about 5 volume percent to about 20 volume percent of a total volume of an insulative hydrophilic polymer hydrogel composition.

In some embodiments, the gas bubbles can be formed of argon bubbles, helium bubbles, krypton bubbles, xenon bubbles, carbon dioxide bubbles, air bubbles, nitrogen bubbles, perfluorooctylbromide bubbles, perfluorodecalin bubbles, perfluorobutane bubbles, perfluoropropane bubbles, perfluorohexane bubbles, or any combination thereof. In some embodiments, the gas bubbles can be formed of argon bubbles, helium bubbles, krypton bubbles, xenon bubbles, carbon dioxide bubbles, nitrogen bubbles, or any combination thereof. In some embodiments, the gas bubbles can include carbon dioxide gas bubbles. In some embodiments, the gas bubbles can consist essentially of carbon dioxide gas bubbles. In some embodiments, the gas bubbles can consist of (only include) carbon dioxide gas bubbles. In some embodiments, the gas bubbles can include air bubbles (e.g., are a mixture of oxygen, nitrogen, argon, carbon dioxide, etc.). In some embodiments, the gas bubbles can consist essentially of air bubbles. In some embodiments, the gas bubbles can consist of (only include) air bubbles. In some embodiments, the gas bubbles can include argon bubbles. In some embodiments, the gas bubbles can consist essentially of argon bubbles. In some embodiments, the gas bubbles can consist of (only include) argon bubbles. In some embodiments, the gas bubbles can include nitrogen bubbles. In some embodiments, the gas bubbles can consist essentially of nitrogen bubbles. In some embodiments, the gas bubbles can consist of (only include) nitrogen bubbles.

In some embodiments, the gas bubbles can be gas bubbles that have a thermal conductivity value (e.g., thermal conductivity of a gas or solid measured in Watts per minute per degrees Kelvin (W/m·K)) that is less than 0.03 W/(m·K) at 300K. In some embodiments, the gas bubbles can be gas bubbles that have a thermal conductivity value that is less than 0.024 W/m·K. In some embodiments, the gas bubbles can be gas bubbles that have a thermal conductivity value that is less than 0.022 W/(m·K). In some embodiments, the gas bubbles can be gas bubbles that have a thermal resistance value that is less than 0.020 W/(m·K). In some embodiments, the gas bubbles can be gas bubbles that have a thermal resistance value that is less than 0.018 W/(m·K). For instance, the gas bubbles can be carbon dioxide gas bubbles (e.g., having a thermal resistance value that is equal to 0.015 W/(m·K)), among other possibilities.

In some embodiments, the gas bubbles can have an average diameter in a range from about 1 microns to about 10,000 microns. All individual values from 1 micron to 10,000 microns are included. In some embodiments, each of the gas bubbles can be substantially the same size. The gas bubbles contemplated herein (e.g., which are intentionally created and remain disposed within the hydrogel) may be larger than (e.g., have a larger average diameter than) a gas bubble that may be inherently or inadvertently trapped within a typical hydrogel during formation thereof. Due to the relatively large size and/or the relatively high concentration of the gas bubbles, the insulative hydrophilic polymer hydrogel compositions herein exhibit enhanced insulative properties (e.g., improved thermal resistance values) as compared to other approaches such as those with an absence of or a de minimis amount of gas bubbles disposed in a material such as a typical hydrogel.

In some embodiments, the gas bubbles can be formed from the same type of gas, can each be substantially the same size and shape, and/or can be substantially uniformly disposed throughout an entity of the insulative hydrophilic polymer hydrogel composition. In some embodiments, each of the gas bubbles disposed in the insulative hydrophilic polymer hydrogel composition can be formed of the same type of gas. For instance, each of the gas bubbles can be formed of an individual gas (e.g., carbon dioxide) or substantially the same gas mixture (e.g., air). In some embodiments, the gas bubbles can be formed of the same gas (e.g., carbon dioxide), can be substantially the same size, and can have a substantially uniform dispersion throughout the insulative hydrophilic polymer hydrogel composition. Having the gas bubbles be formed of the same type of gas, be substantially the same size, and be disposed substantially uniformly through the insulative hydrophilic polymer hydrogel composition can promote aspects herein such as providing uniform thermal resistance throughout the insulative hydrophilic polymer hydrogel composition and/or can provide uniform mechanical properties of the insulative hydrophilic polymer hydrogel composition (e.g., which may case placement and/or shaping of the insulative hydrophilic polymer hydrogel composition within a subject at a target site), etc. However, in some instances a first region of the insulative hydrophilic polymer hydrogel composition may have a different concentration, size, shape, and/or type of gas bubble than another region of the insulative hydrophilic polymer hydrogel composition.

In some embodiments, at least some of the gas bubbles are disposed in interstitial spaces between crosslinks of the hydrophilic polymer hydrogel (e.g., a crosslinked hydrophilic polymer hydrogel). For instance, a majority or all of the gas bubbles can be disposed between crosslinks of the hydrophilic polymer hydrogel. Having the gas bubbles be disposed in the interstitial spaces between crosslinks can promote aspects herein such as promoting retention of the gas bubbles within the insulative hydrophilic polymer hydrogel composition, and thereby maintaining the improved insulative properties of the insulative hydrophilic polymer hydrogel composition during and/or after placement of a spacer formed thereof at a target site in a subject.

In some embodiments, the gas bubbles can be embedded within a foam or within a shell such as a lipid shell or a polymer shell. The gas bubbles that are embedded within the foam or shell can be in (e.g., entrained in) one or more constituents suitable for formation of a hydrophilic polymer hydrogel. For instance, the gas bubbles can be embedded at least partially within cells of an open cell foam or within cells of a closed cell foam. That is, the cells of the foam can be configured (e.g., sized and shaped) to at least partially retain one or more gas bubbles therein. For instance, the cells of the foam can be sized to have an average diameter than is larger than an average diameter of the gas bubbles, as described herein. The foam (e.g., the cells of the foam) can be formed prior to, during, and/or subsequent to formation of the gas bubbles and/or the hydrophilic polymer hydrogel. In some examples, the foam can be biodegradable, chemically inert, or both biodegradable and chemically inert.

In some embodiments, the gas bubbles can be embedded within a shell such as a lipid shell or a polymer shell. A lipid shell can be formed of one more lipids (e.g., phospholipids). Examples of suitable lipid-based shells are described in “Lipid-shelled vehicles: engineering for ultrasound molecular imaging and drug delivery”; Katherine W. Ferrara, Mark A Borden, and Hua Zhang; Department of Biomedical Engineering, 451 Health Sciences Drive, UC Davis, Davis, CA 95616; Acc Chem Res. 2009 Jul. 21; 42 (7): 881-892. The polymer shell can be formed of the same polymer or a different polymer than a polymer employed to form the hydrophilic polymer hydrogel. In some examples, the polymer shell can be formed of a polymer that is biodegradable, chemically inert, or both biodegradable and chemically inert. The polymer shell can be manifested as a polymer bead or polymer balloon, among other possibilities. The polymer bead or polymer shell can be configured (e.g., sized and shaped) to at least partially retain one or more gas bubbles therein. For instance, the polymer bead or polymer shell can be sized to have an average diameter than is larger than an average diameter of the gas bubbles. In some embodiments, the polymer bead or polymer balloon can be formed prior to, during, and/or subsequent to formation of the gas bubbles and/or the hydrophilic polymer hydrogel.

In some examples the polymer shell is a polymer bead. The polymer bead can be a substantially spherical polymer bead, among other possible shapes. In some examples, the polymer shell can be a polymer balloon. The polymer balloon can be an elongate polymer balloon, among other possible shapes.

In some embodiments, the gas bubbles can be formed within a hydrophilic polymer hydrogel prior to, during, and/or subsequent to delivery of the hydrophilic polymer hydrogel to a subject, as described herein. Stated differently, the insulative hydrophilic polymer hydrogel compositions herein can be formed prior to, during, and/or subsequent to delivery of a material (e.g., the hydrophilic polymer hydrogel or the insulative hydrophilic polymer hydrogel composition) to target site within a subject. In some embodiments, the gas bubbles can be formed prior to, during formation of, or subsequent to formation of cross-links in the polymer hydrogel composition, as described herein.

The gas bubbles may be formed as a result of a chemical reaction and/or may be formed via mechanical agitation, as described herein. In some embodiments, the gas bubbles can be formed exclusively (only) via a chemical reaction. In some embodiments, the gas bubbles can be formed exclusively (only) via mechanical agitation. In some embodiments, the gas bubbles can be formed from a combination of a chemical reaction and mechanical agitation.

As a first example, the gas bubbles can be formed ex vivo within the hydrophilic polymer hydrogel to form an insulative hydrophilic polymer hydrogel composition and can subsequently be delivered to a subject as a preformed insulative hydrophilic polymer hydrogel composition using the chemical bubble formation agents and/or mechanical bubble formation devices described herein. For instance, the gas bubble can be formed ex vivo in a preformed hydrogel with a mechanical bubble formation device, as detailed herein. For example, the gas bubbles could be formed ex vivo within a shell such as a lipid shell or polymer shell as a preformed shell including one or more bubbles and the preformed shell can be subsequently included within one or more constituents suitable for formation of a hydrogel that can be delivered to a subject (e.g., as a preformed insulative hydrophilic polymer hydrogel composition).

As a second example, the gas bubbles can be formed in the hydrophilic polymer hydrogel while delivering the hydrophilic polymer hydrogel to a target site within a subject using the chemical bubble formation agents and/or mechanical bubble formation devices described herein. For instance, the gas bubble can be formed while delivering the hydrogel with a mechanical bubble formation device or a chemical bubble formation agent, as detailed herein.

As a third example, the gas bubbles can be formed in vivo subsequent to delivery of the hydrophilic polymer hydrogel to a target site within a subject using the chemical bubble formation agents and/or mechanical bubble formation devices described herein. For instance, the gas bubble can be formed in vivo subsequent to delivering the hydrogel with a chemical bubble formation agent or combination of chemical bubble agents, as detailed herein.

In some embodiments, the insulative hydrophilic polymer hydrogel composition is biodegradable, chemically inert, or both biodegradable and chemically inert. For instance, the insulative hydrophilic polymer hydrogel composition can be biodegradable and chemically inert.

As mentioned, the hydrophilic polymer hydrogels herein are configured to form insulative hydrophilic polymer hydrogel compositions. The hydrophilic polymer hydrogels herein comprise crosslinks between hydrophilic polymer chains within the hydrophilic polymer hydrogel. The crosslinks and/or polymer chains define interstitial spaces within the hydrophilic polymer hydrogel.

In some embodiments, the crosslinks are formed of ester cross-linkages (e.g., those found in SpaceOAR® and SpaceOAR Vue® hydrogels) that upon exposure to water (H₂O) an ester linkage can be hydrolyzed breaking down the hydrogel into a hydroxyl-terminated PEG and a (3-carboxylpropyl)amide-terminated-lysine residue.

However, in some embodiments the crosslinks can include crosslinks with a tunable hydrolysis rates and/or crosslinks which contain immolative linkers or which contain reversible covalent linkages that incorporate reactive dimeric linkers. In some embodiments, a cleavage composition, as described herein, may be employed to break the crosslinks at the position of the immolative linkers within the crosslinks. In some embodiment, a cleavage composition, as described herein, may be employed to break the crosslinks at the position of the dimeric linkers within the crosslinks.

Examples of suitable hydrophilic polymer hydrogels (e.g., with tunable hydrolysis rates) are described in U.S. provisional application No. 63/596,866-titled, “CROSSLINKED HYDROGELS WITH ENHANCED RADIOPACITY FOR MEDICAL APPLICATIONS”, the entire contents of which is incorporated by reference herein. For instance, a hydrophilic polymer hydrogel that has cross-links with tunable hydrolysis rates can include a reactive multi-arm polymer comprising a core region and a plurality of polymer arms having reactive moieties, each polymer arm comprising a polymer segment linked to the core region and one of the plurality of reactive moieties linked to the polymer segment through a hydrolysable linkage selected from a carbonate linkage, an acid anhydride linkage, an imide linkage, a ketal linkage, a carbamate linkage, an organophosphate ester linkage, a silane linkage, an amide linkage, a hydrozonium linkage, an acylhydrozone linkage, an oxime linkage and an amidohydrozone linkage.

Additional examples of suitable hydrophilic polymer hydrogels (e.g., with crosslinks that include immolative linkers and/or reversible covalent linkages that incorporate reactive dimeric linkers) are described in U.S. provisional application No. 63/549,171-titled, “SYSTEMS AND METHODS FOR ON-DEMAND CLEAVAGE OF HYDROGELS”, the entire contents of which is incorporated by reference herein. For example, hydrophilic polymer hydrogels which employ crosslinks that have immolative linkers and/or reversible covalent linkages can be provided as a kit for delivering and degrading a hydrophilic polymer hydrogel, the kit comprising (a) a hydrogel delivery system configured to deliver a hydrophilic polymer hydrogel to a subject, the hydrophilic polymer hydrogel comprising hydrophilic polymer chains that are crosslinked by crosslinks that comprise immolative linkers or by crosslinks that contain reversible covalent linkages that incorporate a reactive dimeric linker and (b) a hydrogel cleavage system configured to deliver a cleavage composition to the subject, wherein the cleavage composition contains a singly reactive molecule that acts to break the crosslinks at a position of the immolative linkers within the crosslinks or wherein the cleavage composition contains a singly reactive molecule that acts to break the crosslinks at a position of the dimeric linkers within the crosslinks.

In some embodiments, the hydrophilic polymer hydrogels herein comprise hydrophilic polymer chains that are crosslinked by: immolative linkers or by crosslinks that contain reversible covalent linkages that incorporate a reactive dimeric linker, such as those described herein; or a hydrolysable linkage selected from a carbonate linkage, an acid anhydride linkage, an imide linkage, a ketal linkage, a carbamate linkage, an organophosphate ester linkage, a silane linkage, an amide linkage, a hydrozonium linkage, an acylhydrozone linkage, an oxime linkage and an amidohydrozone linkage, such as those described herein.

As mentioned, the insulative hydrophilic polymer hydrogel compositions herein may be formed in situ within a subject, may be formed while delivering a hydrophilic polymer hydrogel to a subject, or may be formed ex vivo and subsequently delivered to a subject.

Preferred subjects include mammalian subjects, particularly human subjects.

As used herein, a “hydrogel” is a crosslinked polymer that contains water or can absorb water but does not dissolve when placed in water.

As used herein, an “insulative hydrophilic polymer hydrogel composition” is a hydrogel that contains gas bubbles dispersed therein (present in the relative amounts herein) and that contains water or can absorb water but does not dissolve when placed in water.

As used herein an “immolative linker” is defined as a transient covalent bond that can be cleaved through the addition of a triggering molecule.

As used herein a “singly reactive compound” is defined as a compound that will only undergo one reaction with a desired substrate.

As used herein, the term “substantially” does not refer to an exact value but instead refers to approximate values or ranges of values a skilled person would seek to achieve the same purpose or function. For instance, values that are substantially the same as a stated value may be within about 1 percent, within 5 percent, or within 10 percent of the stated value.

Polymer chains for use herein, including those schematically represented in the preceding schemes with the letter A, may be selected from any of a variety of synthetic, natural, or hybrid synthetic-natural polymer chains. Examples of polymer chains include those that are formed from one or more monomers selected from the following: C₁-C₆-alkylene oxide monomers (e.g., ethylene oxide, propylene oxide, tetramethylene oxide, etc.), cyclic ester monomers (e.g., glycolide, lactide, β-propiolactone, β-butyrolactone, γ-butyrolactone, γ-valerolactone, δ-valerolactone, ε-caprolactone, etc.), oxazoline monomers (e.g., oxazoline and 2-alkyl-2-oxazolines, for instance, 2-(C₁-C₆ alkyl)-2-oxazolines, including various isomers, such as 2-methyl-2-oxazoline, 2-ethyl-2-oxazoline, 2-n-propyl-2-oxazoline, 2-isopropyl-2-oxazoline, 2-n-butyl-2-oxazoline, 2-isobutyl-2-oxazoline, 2-hexyl-2-oxazoline, etc.), and 2-phenyl-2-oxazoline, polar aprotic vinyl monomers (e.g., N-vinyl pyrrolidone, acrylamide, N-methyl acrylamide, dimethyl acrylamide, N-vinylimidazole, 4-vinylimidazole, sodium 4-vinylbenzenesulfonate, etc.), dioxanone, N-isopropylacrylamide, amino acids, peptoids (e.g. N-substituted glycines, including N-methyl glycine or sarcosine), and sugars.

Polymer chains may be selected, for example, from the following polymer chains: polyether chains including poly(C₁-C₆-alkylene oxide) chains such as poly(ethylene oxide) (PEO) chains (also referred to as polyethylene glycol chains or PEG chains), poly(propylene oxide) chains, poly(ethylene oxide-co-propylene oxide) chains, polyester chains including polyglycolide chains, polylactide chains, poly(lactide-co-glycolide) chains, poly(β-propiolactone) chains, poly(β-butyrolactone) chains, poly(γ-butyrolactone) chains, poly(γ-valerolactone) chains, poly(δ-valerolactone) chains, and poly(ε-caprolactone) chains, polyoxazoline chains including poly(2-C₁-C₆-alkyl-2-oxazoline chains) such as poly(2-methyl-2-oxazoline) chains, poly(2-ethyl-2-oxazoline) chains, poly(2-propyl-2-oxazoline) chains, poly(2-isopropyl-2-oxazoline) chains, and poly(2-n-butyl-2-oxazoline) chains, poly(2-phenyl-2-oxazoline) chains, polymer chains formed from one or more polar aprotic vinyl monomers, including poly(N-vinyl pyrrolidone) chains, poly(acrylamide) chains, poly(N-methyl acrylamide) chains, poly(dimethyl acrylamide) chains, poly(N-vinylimidazole) chains, poly(4-vinylimidazole) chains, and poly(sodium 4-vinylbenzenesulfonate) chains, polydioxanone chains, poly(N-isopropylacrylamide) chains, polypeptide chains, polypeptoid chains (e.g., poly(N-substituted glycines), including polysarcosine), and hydrophilic polymer chains.

Polymer chains may contain between 10 and 10000 monomer units or more.

In various embodiments, polymer chains, including those schematically represented in the preceding schemes with the letter A, a part of a multi-arm polymer where three or more polymer arms that comprise the polymer chains extend from a core region. The multi-arm polymers have three or more polymer arms (e.g., between three and fifteen polymer arms). General classes of core regions include residues of polyols, including sugars (monosaccharides, disaccharides, trisaccharides, etc.) and sugar alcohols, calixaranes, polyhedral oligomeric silsesquioxanes (POSS), cyclodextrin, polyhydroxylated polymers, catechins, flavanols, anthocyanins, stilbenes, and polyphenols, among many others.

In some embodiments, the present methods may comprise contacting a hydrophilic polymer hydrogel, e.g., which comprises hydrophilic polymer chains that are crosslinked by crosslinks that comprise immolative linkers or by crosslinks that contain reversible covalent linkages that incorporate reactive dimeric linkers, with a cleavage composition that comprises a singly reactive molecule. For example, in the event that it is desirable to remove a hydrophilic polymer hydrogel from a subject (e.g., because therapy is complete, because the crosslinked hydrophilic polymer is causing discomfort, because the hydrophilic polymer hydrogel is improperly placed, etc.), the crosslinked hydrophilic polymer may be contacted with the cleavage composition. Contacting may include, for example, applying the cleavage composition onto a surface of the insulating hydrophilic polymer hydrogel composition, injecting the cleavage composition into the insulating hydrophilic polymer hydrogel composition, and so forth.

In some embodiments, the cleavage composition contains a singly reactive molecule that acts to break the crosslinks at the position of the immolative linkers within the crosslinks. In some embodiments, the cleavage composition contains a singly reactive molecule that acts to break the crosslinks at the position of the dimeric linkers within the crosslinks.

In some embodiments, the present disclosure provides hydrogels that are configured to form an insulative hydrophilic polymer hydrogel composition such as those that comprise a reaction product of a multifunctional crosslinker and a multi-arm polymer having polymer chains that are reactive with the multifunctional crosslinker.

In some embodiments, the multifunctional crosslinker is a dimeric reactive linker, and hydrogels are formed that comprise a reaction product of the dimeric reactive linker and a multi-arm polymer wherein functional groups at the ends of hydrophilic polymer chains that form the arms of the multi-arm polymer are reversibly crosslinked with the dimeric reactive linker.

In some embodiments, hydrophilic polymer hydrogels are formed that comprise a reaction product of the multifunctional crosslinker and a multi-arm polymer wherein functional groups of the multifunctional crosslinker irreversibly react with functional groups at the ends of hydrophilic polymer chains that form the arms of the multi-arm polymer, creating crosslinks that contain immolative linkers.

In some embodiments of the present disclosure, systems are provided that are configured to deliver (a) a multifunctional crosslinker as described herein and (b) a multi-arm polymer as described herein. When the multifunctional crosslinker and the multi-arm polymer are comingled, crosslinks are formed between the multifunctional crosslinker and the multi-arm polymer. Such systems can be used to form hydrophilic polymer hydrogels in vivo within a subject. In such instances, an insulative hydrophilic polymer hydrogel composition including gas bubbles, can be formed in vivo within a subject, as described herein. Such systems can also be used to form hydrophilic polymer hydrogels ex vivo, which are subsequently introduced to a subject. In such instances, an insulative hydrophilic polymer hydrogel compositions including gas bubbles, can be formed ex vivo (e.g., gas bubbles can be formed within the hydrophilic polymer hydrogels prior to or during delivery of the hydrophilic polymer hydrogels to the subject) can be subsequently introduced to a subject.

In any case, the gas bubbles can be formed and remain disposed within the hydrophilic polymer hydrogel to form an insulative hydrophilic polymer hydrogel compositions that are suitable to be positioned within the subject. Subsequent to positioning the insulative hydrophilic polymer hydrogel composition within the subject, the insulative hydrophilic polymer hydrogel composition may, in some embodiments, be contacted with a cleavage composition that is adapted to break down the crosslinks within the insulative hydrophilic polymer hydrogel composition, in some embodiments.

While various figures illustrate the target site as being between the prostate and rectum of a subject other target sites within a subject are possible. For instance, the insulative hydrophilic polymer hydrogel compositions described herein may be employed in conjunction with ablation therapies such cryoablation and radiofrequency ablation (RFA) on various other organs.

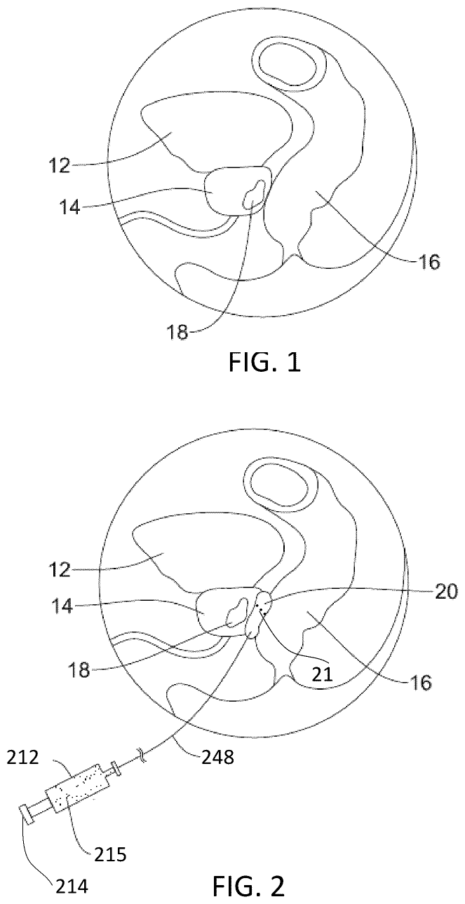

FIG. 1 is a schematic overview depicting a region of the human body including, for example, the bladder 12, prostate 14, and rectum 16. In this example, the prostate 14 may include a tumor 18. In some instances, it may be desirable to treat the tumor 18 with ablation therapy. Prior to ablation therapy, it may be desirable to place an insulating hydrophilic polymer hydrogel spacer 20 in the human body.

As shown in FIG. 2, a preloaded syringe, in which a hydrophilic polymer hydrogel configured to form an injectable insulating hydrophilic polymer hydrogel or an injectable insulating hydrophilic polymer hydrogel composition 215 is disposed within a delivery syringe system that includes a syringe barrel 212 and a plunger 214, may be connected to a needle 248 the distal tip of which is positioned between the prostate 14 and rectum 16. The plunger 214 may be used to deliver the hydrophilic polymer hydrogel configured to form an injectable insulating hydrophilic polymer hydrogel composition or may directly inject the injectable insulating hydrophilic polymer hydrogel composition 215 to form an insulating hydrophilic polymer hydrogel spacer 20. That is, the hydrophilic polymer hydrogel may be delivered and the insulating hydrophilic polymer hydrogel composition which forms the insulating hydrophilic polymer hydrogel spacer 20 may be formed in-vivo or during delivery, or alternatively, a pre-formed injectable insulating hydrophilic polymer hydrogel composition may be formed ex-vivo and delivered to a target site in a subject to form the insulating hydrophilic polymer hydrogel spacer 20, as described herein.

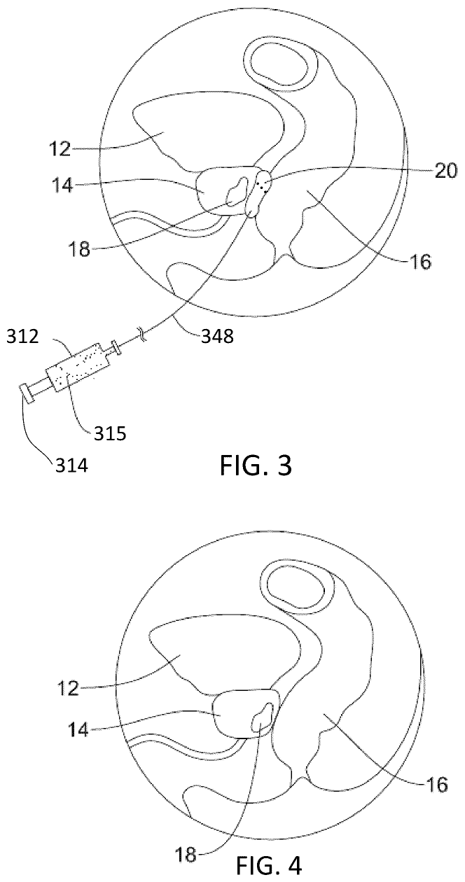

With the prostate 14 spaced from and insulated (e.g., thermally insulated) from the rectum 16 by the insulating hydrophilic polymer hydrogel spacer 20, thermal ablation and/or radiation therapy may be used to treat the tumor 18. For instance, as shown in FIG. 2, the insulating hydrophilic polymer hydrogel spacer 20 includes gas bubbles (represented by elements 21) disposed therein. While a given quantity of gas bubbles 21 is shown to ease illustration in FIGS. 2 and 3, the insulating hydrophilic polymer hydrogel spacer 20 can include a larger quantity of gas bubbles (e.g., dispersed substantially uniformly therein), as detailed herein. Accordingly, the insulating hydrophilic polymer hydrogel spacer 20 exhibits enhanced insulative properties (e.g., enhanced thermal insulation) as compared to other approaches such as those the employ spacers with an absence of gas bubbles (e.g., an absence of a substantially uniform dispersion of gas bubbles), as described herein.

In some embodiments, the insulating hydrophilic polymer hydrogel spacer 20 may be configured to permit triggered/on-demand degradation. In such instances, when cleavage of the insulating hydrophilic polymer hydrogel spacer 20 is desired, a cleavage composition may be contacted with the insulative hydrophilic polymer hydrogel spacer 20 in order to accelerate cleavage of the same. For instance, as shown in FIG. 3, a preloaded syringe, in which a cleavage composition 315 is disposed within a cleavage syringe system that includes a syringe barrel 312 and a plunger 314, may be connected to a needle 348 the end of which is positioned in the hydrophilic polymer hydrogel spacer 20. The plunger 314 may be used to deliver the cleavage composition 315 to the insulative hydrophilic polymer hydrogel spacer 20 as schematically depicted in FIG. 3. The cleavage composition 315 may act to degrade the insulative hydrophilic polymer hydrogel spacer 20 as schematically depicted in FIG. 4.

It is noted that in some cases (e.g., wherein it is immediately apparent that the insulative hydrophilic polymer hydrogel spacer 20 has been misplaced), the needle 348 may be the same as the needle 248 that was used to initially introduce the insulative hydrophilic polymer hydrogel spacer 20, allowing the preloaded syringe barrel 212 to be disconnected from the needle 248 and the preloaded syringe barrel 212 to be connected to the same needle without withdrawing needle from the subject.

In the preceding embodiment, the insulative hydrophilic polymer hydrogel spacer 20 is completely removed from the subject. In other embodiments, the cleavage composition is contacted with the insulative hydrophilic polymer hydrogel spacer 20 in a manner such that only a portion of the crosslinks are broken, leading to softening and/or swelling of the hydrophilic polymer hydrogel in situ.

In some embodiments, the present disclosure pertains to a system that comprises (a) an injectable or implantable composition comprising a pre-formed insulative hydrophilic polymer hydrogel composition and (b) a cleavage composition that acts to break the crosslinks within the hydrophilic polymer hydrogel.

Various cleavage compositions are described above and include at least one singly reactive molecule. The cleavage compositions may be provided in a suitable reservoir such as a syringe, vial or ampule, as described herein.

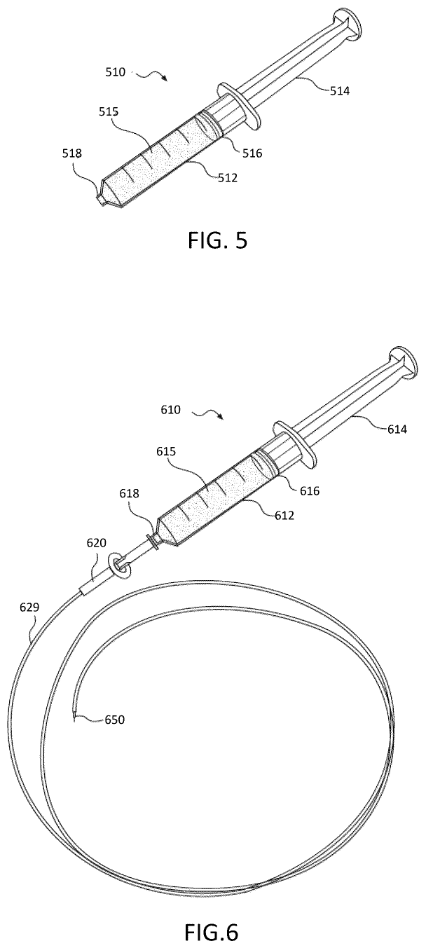

FIG. 5 illustrates a syringe 510 for injection of a hydrophilic polymer hydrogel configured to form an insulative hydrophilic polymer hydrogel composition, an insulative hydrophilic polymer hydrogel composition, and/or a cleavage composition as discussed above. The syringe 510 may comprise a barrel 512, a plunger 514, and one or more stoppers 516. The barrel 512 may include a Luer adapter (or other suitable adapter/connector) at the distal end 518 of the barrel 512, suitable for attachment to an injection needle or a flexible catheter. The syringe barrel 512 may serve as a reservoir containing the hydrophilic polymer hydrogel configured to form an insulative hydrophilic polymer hydrogel composition, an insulative hydrophilic polymer hydrogel composition, and/or a cleavage composition, for injection into a subject, for example, through a needle or catheter.

Pre-formed hydrophilic polymer hydrogels configured to form insulative hydrophilic polymer hydrogel compositions may be in any desired form, including a slab, a cylinder, a coating, or particles. In some embodiments, the pre-formed hydrophilic polymer hydrogel configured to form insulative hydrophilic polymer hydrogel compositions is dried and then granulated into particles of suitable size. Granulating may be by any suitable process, for instance by homogenization, forcing through a screen, grinding (including cryogrinding), crushing, milling, pounding, or the like. Sieving or other known techniques can be used to classify and fractionate the particles.

The pre-formed hydrophilic polymer hydrogels configured to form an insulative hydrophilic polymer hydrogel compositions, a pre-formed insulative hydrophilic polymer hydrogel composition, and/or a cleavage compositions, as discussed above, may be provided in any suitable packaging such as a syringe, vial or ampule. Whether supplied in a syringe, vial, ampule or other reservoir, the hydrophilic polymer hydrogel configured to form an insulative hydrophilic polymer hydrogel composition, an insulative hydrophilic polymer hydrogel composition, and/or a cleavage composition, as discussed above, may be provided, for example, in dry form (e.g., in the form of a powder that contains hydrophilic polymer hydrogel particles) or in a fluid form (e.g., in the form of a suspension that contains hydrophilic polymer hydrogel particles).

The insulative hydrophilic polymer hydrogel compositions may be delivered to a subject using a suitable delivery device.

One exemplary delivery device is shown in FIG. 6, which illustrates a syringe 610 providing a reservoir e.g., which may contain a pre-formed insulative hydrophilic polymer hydrogel composition as discussed above. The syringe 610 may comprise a barrel 612, a plunger 614, and one or more stoppers 616. The barrel 612 may include a Luer adapter (or other suitable adapter/connector), e.g., at the distal end 618 of the barrel 612, for attachment to an injection needle 650 via a flexible catheter 629. The proximal end of the catheter 629 may include a suitable connection 620 for receiving the barrel 612. In other examples, the barrel 612 may be directly coupled to the injection needle 650. The syringe barrel 612 may serve as a reservoir, containing a pre-formed insulative hydrophilic polymer hydrogel composition 615 for injection through the needle 650.

The insulative hydrophilic polymer hydrogel compositions described herein can be used for a number of medical purposes.

For example, the insulative hydrophilic polymer hydrogel compositions herein can be injected to provide spacing between tissues, the insulative hydrophilic polymer hydrogel compositions can be injected to provide fiducial markers, the insulative hydrophilic polymer hydrogel compositions can be injected for tissue augmentation or regeneration, including cosmetic tissue augmentation, the insulative hydrophilic polymer hydrogel compositions can be injected as a filler or replacement for soft tissue, the insulative hydrophilic polymer hydrogel compositions can be injected to provide mechanical support for compromised tissue, the insulative hydrophilic polymer hydrogel compositions can be injected as a scaffold, the insulative hydrophilic polymer hydrogel compositions can be injected as lifting agents for internal cyst removal, and/or the insulative hydrophilic polymer hydrogel compositions can be injected as a carrier of therapeutic agents in the treatment of diseases and cancers and the repair and regeneration of tissue, among other uses. The insulative hydrophilic polymer hydrogel compositions can also be injected into a left atrial appendage during a left atrial appendage closure procedure. In some embodiments, the insulative hydrophilic polymer hydrogel compositions may be injected into the left atrial appendage after the introduction of a closure device such as the Watchman® left atrial appendage closure device available from Boston Scientific Corporation.

The insulative hydrophilic polymer hydrogel compositions of the present disclosure may be used in a variety of medical procedures, including the following, among others: a procedure to implant a fiducial marker comprising an insulative hydrophilic polymer hydrogel, a procedure to implant a tissue regeneration scaffold comprising an insulative hydrophilic polymer hydrogel, a procedure to implant a tissue support comprising an insulative hydrophilic polymer hydrogel, a procedure to implant a tissue bulking agent comprising an insulative hydrophilic polymer hydrogel, a procedure to implant a therapeutic-agent-containing depot comprising an insulative hydrophilic polymer hydrogel, a tissue augmentation procedure comprising implanting an insulative hydrophilic polymer hydrogel, a procedure to introduce an insulative hydrophilic polymer hydrogel between a first tissue and a second tissue to space the first tissue from the second tissue.

The insulative hydrophilic polymer hydrogel compositions may be injected in conjunction with a variety of medical procedures including the following: injection between the prostate or vagina and the rectum for spacing in radiation therapy for rectal cancer, injection between the rectum and the prostate for spacing in radiation therapy for prostate cancer, subcutaneous injection for palliative treatment of prostate cancer, transurethral or submucosal injection for female stress urinary incontinence, intra-vesical injection for urinary incontinence, uterine cavity injection for Asherman's syndrome, submucosal injection for anal incontinence, percutaneous injection for heart failure, intra-myocardial injection for heart failure and dilated cardiomyopathy, injection for closure of an atrial septal defect, trans-endocardial injection for myocardial infarction, intra-articular injection for osteoarthritis, spinal injection for spinal fusion, and spine, oral-maxillofacial and orthopedic trauma surgeries, spinal injection for posterolateral lumbar spinal fusion, intra-discal injection for degenerative disc disease, injection between pancreas and duodenum for imaging of pancreatic adenocarcinoma, resection bed injection for imaging of oropharyngeal cancer, injection around circumference of tumor bed for imaging of bladder carcinoma, submucosal injection for gastroenterological tumor and polyps, visceral pleura injection for lung biopsy, kidney injection for type 2 diabetes and chronic kidney disease, renal cortex injection for chronic kidney disease from congenital anomalies of kidney and urinary tract, intravitreal injection for neovascular age-related macular degeneration, intra-tympanic injection for sensorineural hearing loss, dermis injection for correction of wrinkles, creases and folds, signs of facial fat loss, volume loss, shallow to deep contour deficiencies, correction of depressed cutaneous scars, perioral rhytids, lip augmentation, facial lipoatrophy, stimulation of natural collagen production.

In various embodiments, kits are provided that include one or more delivery devices for delivering at least: a first component (a) hydrophilic polymer hydrogel configured to form an insulative hydrophilic polymer hydrogel composition or an insulative hydrophilic polymer hydrogel composition such as a pre-formed hydrophilic polymer hydrogel composition as described herein and a second component (b) a cleavage composition as described herein to a subject. Such kits may include any of the following: one or more syringes, which may or may not contain the first component (a) or the second component (b); one or more vials, which may or may not contain the first component (a) or the second component (b); one or more needles (which may be compatible both with a delivery syringe system for delivering the first component (a) or the second component (b)); one or more flexible tubes (which may be compatible both with a syringe for delivering the first component (a) and a syringe for delivering the second component (b); and an injectable liquid such as water for injection, normal saline or phosphate buffered saline. Whether supplied in a syringe, vial, or other reservoir, the first component (a) or the second component (b) may independently be provided in dry form (e.g., powder form) or in a fluid form, which may be ready for injection.

In some aspects, the kit can include a third component (c) which is configured to chemically and/or mechanically form the gas bubbles within the hydrophilic polymer hydrogel configured to form an insulative hydrophilic polymer hydrogel composition. The third component can be manifested as a chemical bubble formation agent or a mechanical bubble formation device. Examples of suitable chemical bubble formation agents include one or more components suitable for formation of or that are included in shells (e.g., lipid shells or polymer shells in which one or more gas bubbles are embedded), as described herein, and/or one or more components (e.g., reactive components such as isocyanate, polyols, etc.) that are suitable to form various types of foams in which the gas bubbles are embedded, as described herein. For instance, the chemical bubble formation agents can include one or more lipids (e.g., which are suitable for formation of a lipid shell or which are included in a preformed lipid shell in which one or more bubbles are embedded), one or more polymers (e.g., which are suitable for formation of a polymer shell and/or which are included in a preformed polymer shell in which one or more bubbles are embedded), and/or at least two components that when combined chemically react and form gas bubbles as a byproduct or result of the chemical reaction. The introduction of the gas bubbles with the chemical bubble formation agent can occur ex vivo, during delivery of the hydrogel, or in vivo. Examples of suitable mechanical bubble formation devices include tubing such as a catheter or a syringe with one or more side apertures (e.g., radial apertures) extending through a body thereof. In such instances, an additional device such as additional tubing or a second syringe can be coupled to the one or more side apertures and gas can be provided via the additional device and the one or more apertures into the body of the tubing or syringe, thereby causing the formation of gas bubbles within a media (e.g., one or more components suitable for forming a hydrogel). However, in some instances, the gas (e.g., air) can be introduced passively (in the absence of the additional device) via the one or more side apertures. The introduction of gas with the mechanical bubble device can occur ex vivo, during delivery of the hydrogel, or in vivo.

Compositions for forming a hydrophilic polymer hydrogel within a subject are described above and include a multifunctional crosslinker as described above and a multi-arm polymer having polymer chains that are reactive with the multifunctional crosslinker as described above (also referred to herein as a reactive multi-arm polymer).

The reactive multi-arm polymer may be provided in a suitable reservoir such as a syringe, vial or ampule. Whether supplied in a syringe, vial, ampule or other reservoir, the reactive multi-arm polymer may be provided, for example, in dry form (e.g., powder form) or in fluid form, such as in a solution form.

The multifunctional crosslinker also may be provided in a suitable reservoir such as a syringe, vial or ampule. Whether supplied in a syringe, vial, ampule or other reservoir, the multifunctional crosslinker may be provided, for example, in dry form (e.g., powder form) or in fluid form, such as in a solution form.

In some embodiments, the reactive multi-arm polymer and the multifunctional crosslinker are simultaneously administered to the subject, after which crosslinks are formed between the reactive multi-arm polymer and the multifunctional crosslinker.

In some embodiments, a system is provided which includes a delivery device that comprises a first reservoir that contains a first fluid composition that comprises the reactive multi-arm polymer and a second reservoir that contains a second fluid composition that comprises the multifunctional crosslinker. When the first and second fluid compositions are mixed, crosslinking commences between the reactive multi-arm polymer. During operation, the first fluid composition and second fluid composition are dispensed from the first and second reservoirs and combined, whereupon the reactive multi-arm polymer crosslink with one another to form a hydrophilic polymer hydrogel in the subject.

As described herein, gas bubbles can be formed during and/or subsequent to formation of the hydrophilic polymer hydrogel to form an insulative hydrophilic polymer hydrogel composition.

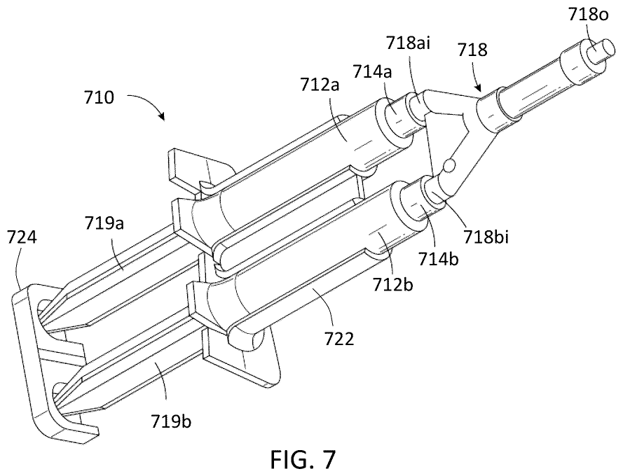

In particular embodiments, and with reference to FIG. 7, a syringe delivery system may include a delivery device 710 that comprises a double-barrel syringe, which includes a first barrel 712a having a first barrel outlet 714a, which first barrel contains a first fluid composition described above, a first plunger 719a that is movable in the first barrel 712a, a second barrel 712b having a second barrel outlet 714b, which second barrel 712b contains a second fluid composition described above, and a second plunger 719b that is movable in the second barrel 712b. In some embodiments, the device 710 may further comprise a mixing section 718 having a first mixing section inlet 718ai in fluid communication with the first barrel outlet 714a, a second mixing section inlet 718bi in fluid communication with the second barrel outlet 714b, and a mixing section outlet 7180. Also shown are a syringe holder 722 configured to hold the first and second syringe barrels 712a, 712b, in a fixed relationship and a plunger cap 724 configured to hold the first and second plungers 719a, 719b in a fixed relationship. In some embodiments, the delivery device may further comprise a needle or catheter tube that is configured to receive the first and second fluid compositions from the first and second barrels. For example, a needle or catheter tube may be configured to form a fluid connection with an outlet of a mixing section by attaching the cannula or catheter tube to an outlet of the mixing section, for example, via a suitable fluid connector such as a luer connector.

Regardless of the type of device that is used to mix the first and second fluid compositions or how the first and second fluid compositions are mixed, immediately after an admixture of the first and second fluid compositions is formed, the admixture initially may be in a fluid state and can be administered to a subject (e.g., a mammal, particularly, a human) by a variety of techniques. Alternatively, the first and second fluid compositions may be administered to a subject independently and a fluid admixture of the first and second fluid compositions formed in or on the subject. In either approach, a fluid admixture of the first and second fluid compositions is created which leads to the formation of a hydrophilic polymer hydrogel composition in the subject. In either approach, first and second fluid compositions or a fluid admixture thereof is introduced into the patient for a variety of medical purposes.

After administration, the compositions of the present disclosure can be imaged using a suitable imaging technique such as an ultrasound or an X-ray-based imaging technique, such as computerized tomography or X-ray fluoroscopy.

As seen from the above, the compositions of the present disclosure may be used in a variety of medical procedures, including the following, among others: a procedure to implant a fiducial marker comprising a hydrophilic polymer hydrogel composition, a procedure to implant a tissue regeneration scaffold comprising a hydrophilic polymer hydrogel composition, a procedure to implant a tissue support comprising a hydrophilic polymer hydrogel composition, a procedure to implant a tissue bulking agent comprising a hydrophilic polymer hydrogel composition, a procedure to implant an embolic composition comprising a hydrophilic polymer hydrogel composition, a procedure to implant a lifting agent comprising a hydrophilic polymer hydrogel composition, a procedure to introduce a left atrial appendage closure composition comprising a hydrophilic polymer hydrogel composition, a procedure to implant a therapeutic-agent-containing depot comprising a hydrophilic polymer hydrogel composition, a tissue augmentation procedure comprising implanting a hydrophilic polymer hydrogel composition, a procedure to introduce a hydrophilic polymer hydrogel composition between a first tissue and a second tissue to space the first tissue from the second tissue.

The first and second fluid compositions or a fluid admixture thereof may be injected in conjunction with a variety of medical procedures including those described herein.

The components and/or compositions described herein include therapeutic agents, imaging agents, colorants, tonicity adjusting agents, suspension agents, wetting agents, and pH adjusting agents.

Examples of therapeutic agents include antithrombotic agents, anticoagulant agents, antiplatelet agents, thrombolytic agents, antiproliferative agents, anti-inflammatory agents, hyperplasia inhibiting agents, anti-restenosis agent, smooth muscle cell inhibitors, antibiotics, antimicrobials, analgesics, anesthetics, growth factors, growth factor inhibitors, cell adhesion inhibitors, cell adhesion promoters, anti-angiogenic agents, cytotoxic agents, chemotherapeutic agents, checkpoint inhibitors, immune modulatory cytokines, T-cell agonists, STING (stimulator of interferon genes) agonists, antimetabolites, alkylating agents, microtubule inhibitors, hormones, hormone antagonists, monoclonal antibodies, antimitotics, immunosuppressive agents, tyrosine and serine/threonine kinases, proteasome inhibitors, mRNA, matrix metalloproteinase inhibitors, Bcl-2 inhibitors, DNA alkylating agents, spindle poisons, poly(DP-ribose) polymerase (PARP) inhibitors, and combinations thereof.

Examples of imaging agents include (a) fluorescent dyes such as fluorescein, indocyanine green, or fluorescent proteins (e.g., green, blue, cyan fluorescent proteins), (b) contrast agents for use in conjunction with magnetic resonance imaging (MRI), including contrast agents that contain elements that form paramagnetic ions, such as Gd(III), Mn(II), Fe(III) and compounds (including chelates) containing the same, such as gadolinium ion chelated with diethylenetriaminepentaacetic acid, (c) contrast agents for use in conjunction with ultrasound imaging, including organic and inorganic echogenic particles (i.e., particles that result in an increase in the reflected ultrasonic energy) or organic and inorganic echolucent particles (i.e., particles that result in a decrease in the reflected ultrasonic energy), (d) contrast agents for use in connection with near-infrared (NIR) imaging, which can be selected to impart near-infrared fluorescence to the hydrogels of the present disclosure, allowing for deep tissue imaging and device marking, for instance, NIR-sensitive nanoparticles such as gold nanoshells, carbon nanotubes (e.g., nanotubes derivatized with hydroxy or carboxyl groups, for instance, partially oxidized carbon nanotubes), dye-containing nanoparticles, such as dye-doped nanofibers and dye-encapsulating nanoparticles, and semiconductor quantum dots, among others, and NIR-sensitive dyes such as cyanine dyes, squaraines, phthalocyanines, porphyrin derivatives and boron dipyrromethane (BODIPY) analogs, among others, (e) imageable radioisotopes including 99mTc, 201Th, 51Cr, 67Ga, 68Ga, 111 In, 64Cu, 89Zr, 59Fc, 42K, 82Rb, 24Na, 45Ti, 44Sc, 51Cr and 177Lu, among others, and (f) radiocontrast agents, for example, particles of tantalum, tungsten, rhenium, niobium, molybdenum, and their alloys, which metallic particles may be spherical or non-spherical. Additional examples of radiocontrast agents include non-ionic radiocontrast agents, such as iohexol, iodixanol, ioversol, iopamidol, ioxilan, or iopromide, ionic radiocontrast agents such as diatrizoate, iothalamate, metrizoate, or ioxaglate, and iodinated oils, including ethiodized poppyseed oil (available as Lipiodol®).

Examples of colorants include brilliant blue (e.g., Brilliant Blue FCF, also known as FD&C Blue 1), indigo carmine (also known as FD&C Blue 2), indigo carmine lake, FD&C Blue 1 lake, and methylene blue (also known as methylthioninium chloride), among others.

Examples of additional agents further include tonicity adjusting agents such as sugars (e.g., dextrose, lactose, etc.), polyhydric alcohols (e.g., glycerol, propylene glycol, mannitol, sorbitol, etc.) and inorganic salts (e.g., potassium chloride, sodium chloride, etc.), among others, suspension agents including various surfactants, wetting agents, and polymers (e.g., albumen, PEO, polyvinyl alcohol, block polymers, etc.), among others, and pH adjusting agents including various buffer solutes.

What is claimed is:

1. An insulative hydrophilic polymer hydrogel composition for ablation therapies, the insulative hydrophilic polymer hydrogel composition comprising:
a hydrophilic polymer hydrogel, the hydrophilic polymer hydrogel comprising hydrophilic polymer chains that are crosslinked by crosslinks; and
a plurality of gas bubbles disposed in the hydrophilic polymer hydrogel.

2. The insulative hydrophilic polymer hydrogel composition of claim 1, wherein the plurality of gas bubbles includes argon bubbles, helium bubbles, krypton bubbles, xenon bubbles, carbon dioxide bubbles, air bubbles, nitrogen bubbles, perfluorooctylbromide bubbles, perfluorodecalin bubbles, perfluorobutane bubbles, perfluoropropane bubbles, perfluorohexane bubbles, or any combination thereof.

3. The insulative hydrophilic polymer hydrogel composition of claim 1, wherein the plurality of gas bubbles comprises argon bubbles, helium bubbles, krypton bubbles, xenon bubbles, carbon dioxide bubbles, nitrogen bubbles, or combination thereof.

4. The insulative hydrophilic polymer hydrogel composition of claim 1, wherein the plurality of gas bubbles includes carbon dioxide gas bubbles.

5. The insulative hydrophilic polymer hydrogel composition of claim 1, wherein the plurality of gas bubbles comprises about 1 volume percent to about 40 volume percent of a total volume of the insulative hydrophilic polymer hydrogel composition.

6. The insulative hydrophilic polymer hydrogel composition of claim 1, wherein the plurality of gas bubbles comprises about 10 volume percent to about 40 volume percent of a total volume of the insulative hydrophilic polymer hydrogel composition.

7. The insulative hydrophilic polymer hydrogel composition of claim 1, wherein each of the plurality of gas bubbles has an average diameter in a range from about 1 micron to about 10,000 microns.

8. The insulative hydrophilic polymer hydrogel composition of claim 1, wherein the plurality of gas bubbles is substantially uniformly disposed throughout the hydrophilic polymer hydrogel.

9. The insulative hydrophilic polymer hydrogel composition of claim 1, wherein the plurality of gas bubbles is embedded within cells of a foam, and wherein the foam is an open cell foam or a closed cell foam.

10. The insulative hydrophilic polymer hydrogel composition of claim 1, wherein the plurality of gas bubbles is embedded in a shell.

11. The insulative hydrophilic polymer hydrogel composition of claim 10, wherein the shell is a polymer shell, and wherein the polymer shell is a polymer bead.

12. The insulative hydrophilic polymer hydrogel composition of claim 10, wherein the shell is a polymer shell, and wherein the polymer shell is a polymer balloon.

13. The insulative hydrophilic polymer hydrogel composition of claim 1, wherein the insulative hydrophilic polymer hydrogel composition is biodegradable, chemically inert, or both biodegradable and chemically inert.

14. The insulative hydrophilic polymer hydrogel composition of claim 1, wherein at least some gas bubbles of the plurality of gas bubbles are disposed in interstitial spaces between the crosslinks of the hydrophilic polymer hydrogel.

15. The insulative hydrophilic polymer hydrogel composition of claim 1, wherein the crosslinks comprise:
an immolative linker or a reversible covalent linkage that incorporates a reactive dimeric linker; or
a hydrolysable linkage selected from a carbonate linkage, an acid anhydride linkage, an imide linkage, a ketal linkage, a carbamate linkage, an organophosphate ester linkage, a silane linkage, an amide linkage, a hydrozonium linkage, an acylhydrozone linkage, an oxime linkage and an amidohydrozone linkage.

16. A kit for forming an insulative polymer hydrogel composition for ablation therapies, the kit comprising:
a hydrogel delivery system configured to deliver an insulative hydrophilic polymer hydrogel to a subject, the insulative hydrophilic polymer hydrogel including:
hydrophilic polymer chains that are crosslinked by crosslinks;
a plurality of gas bubbles, wherein at least some gas bubbles of the plurality of gas bubbles are disposed in interstitial spaces between the crosslinks; and
a hydrogel cleavage system configured to deliver a cleavage composition to the subject.

17. The kit of claim 16, wherein the insulative polymer hydrogel composition is a preformed insulative polymer hydrogel composition.

18. A method of forming an insulative hydrophilic polymer hydrogel composition for ablation therapies, the method comprising:
forming a plurality of gas bubbles in a hydrophilic polymer hydrogel to form an insulative hydrophilic polymer hydrogel composition for ablation therapies; and
delivering the insulative hydrophilic polymer hydrogel composition to a subject.

19. The method of claim 18, further comprising delivering a hydrogel cleavage composition to the subject such that the hydrogel cleavage composition contacts the insulative hydrophilic polymer hydrogel composition to break at least some crosslinks in the insulative hydrophilic polymer hydrogel composition.

20. The method of claim 18, further comprising forming the gas bubbles before delivering the insulative hydrophilic polymer hydrogel to the subject, while delivering the insulative hydrophilic polymer hydrogel, or after delivering the hydrophilic polymer hydrogel to the subject.
